(19) United States
(12) Patent Application Publication
(10) Pub. No.: US 2008/0143673 A1
(43) Pub. Date: Jun. 19, 2008

(54) Method and Apparatus For Moving Cursor Using Numerical Keys

(75) Inventor: Chi Young Park, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: XCE CO., LTD., Seocho-gu, Seoul (KR)

(21) Appl. No.: 11/659,673

(22) PCT Filed: Jul. 29, 2005
(86) PCT No.: PCT/KR2005/002471

§ 371 Date: Oct. 24, 2007

(30) Foreign Application Priority Data
Sep. 3, 2004 (KR) 10-2004-0070241
Jan. 10, 2005 (KR) 10-2005-0002172

(51) Int. Cl. G09G 5/08; H04B 1/40; G06F 3/02

(52) U.S. Cl. 345/157; 345/168

(57) ABSTRACT

The object of this invention is to provide a method for moving a cursor using numerical keys. In the cursor movement method, a screen of an information device is divided into sub-screens each. The sub-screens are mapped to respective numerical keys provided on the information device. It is determined whether the numerical keys mapped to the sub-screens have been pressed. The cursor is moved to a sub-screen mapped to a corresponding numerical key and displaying the cursor if it is determined that a numerical key has been pressed. Accordingly, the present invention can easily move the cursor to a desired location in an information communication device lacking a mouse. Therefore, the present invention can perform a function similar to a mouse when a user plays a game, etc. using an information communication device lacking a mouse, such as a mobile phone.

### TECHNICAL FIELD

The present invention relates, in general, to the movement of a cursor and, more particularly, to a method and apparatus for moving a cursor using numerical keys.

### BACKGROUND ART

Interface devices useful for typical computers include devices such as a keyboard or mouse. With the initiation of mobile communication business, a small-sized terminal that provides voice communication and a Short Message Service (SMS) and has input keys was developed in the generation of Code Division Multiple Access (CDMA) 1x. Before long, technology was further developed, and a network enabling both voice communication and data communication has been constructed, so that services provided through small-sized terminals have increased in number and variety. Further, a graphic function for additional services is also becoming spectacular. However, a user interface of a small-sized terminal that is gradually becoming convenient and has improved performance, in particular, a mobile phone, is restricted to numerical keys and character keys due to the size thereof. That is, due to insufficient portability and convenience, a mouse is not used for a user interface. Even though a mouse is not used, technology has been developed, so that a method of inputting various characters, a method of expressing the Hangul alphabet, and Graphic User Interfaces (GUIs) are provided in a mobile phone. However, since the unique function of a mouse, that is, a function of selecting a desired location on a screen, is omitted, the mobile terminal is disadvantageous in that it is inconvenient, so that the range of game software that can be implemented in the mobile phone, etc., is inevitably narrower than that of game software that can be run on typical Personal Computers (PCs).

In order to solve the disadvantage, terminals, such as a Personal Digital Assistant (PDA) or a smart phone, utilizing hardware such as a touch screen, have been developed for a method of performing the function of a mouse of a PC. However, these terminals are expensive for that reason.

### DISCLOSURE OF THE INVENTION

Accordingly, the present invention has been made keeping in mind the above problems occurring in the prior art, and an object of the present invention is to provide a method and apparatus for moving a cursor using numerical keys, which graphically displays a cursor that is movable on the screen of a small-sized terminal, such as a mobile phone, as in the case of a mouse of a computer, even though a mouse is not used for the small-sized terminal, or which graphically displays the border of an entire screen, or a guideline for indicating the size and location of each sub-screen in relation to the entire screen and assisting the selection of keys required to move the cursor, together with the cursor, thus allowing a user to recognize the movement of the cursor and enabling pixel values at a location indicated by the cursor to be used in application software.

In order to accomplish the above object, the present invention provides a method of moving a cursor using numerical keys, comprising the steps of a) dividing a screen of an information device into sub-screens each having a predetermined size; b) mapping the sub-screens obtained at step a) to respective numerical keys provided on the information device; and c) determining whether the numerical keys mapped to the sub-screens at step b) have been pressed, and moving the cursor to a sub-screen mapped to a corresponding numerical key and displaying the cursor if it is determined that a numerical key has been pressed.

Preferably, according to an embodiment of the present invention, the step b) may comprise the step of b1) displaying a first screen border for indicating an entire screen and first guidelines for identifying each of the sub-screens mapped to the numerical keys, together with the cursor.

Preferably, according to another embodiment of the present invention, the step b) may further comprise the step of b2) secondarily dividing each sub-screen, mapped to each numerical key, into secondary sub-screens each having a predetermined size, and mapping the secondary sub-screens to respective numerical keys. Preferably, the step b2) may be repeatedly performed a certain number of times. Preferably, the number of sub-screens formed by dividing the screen may be 9, and the numerical keys may correspond to numerical keys numbered from 1 to 9.

Preferably, according to a further embodiment of the present invention, the step c) may comprise the steps of c1) if an arbitrary numerical key among the mapped numerical keys is pressed, displaying second guidelines for identifying respective secondary sub-screens in a sub-screen mapped to the numerical key and a second screen border for distinguishing an area of the sub-screen from the entire screen; and c2) if an arbitrary numerical key or another numerical key is pressed while a display state of c1) is maintained, moving the cursor to an area of a secondary sub-screen corresponding to the numerical key and displaying the cursor together with the first guidelines and the first screen border, so that a user of the information device can easily recognize a screen area on which the cursor is currently located on the entire screen, thus facilitating the manipulation of keys to move the cursor.

Preferably, according to yet another embodiment of the present invention, the step c2) may be constructed so that the first screen border and the first guidelines are displayed after the second screen border and the second guidelines, displayed at step c1), are removed.

In addition, the present invention provides an apparatus for moving a cursor using numerical keys, comprising a screen division unit for dividing a screen of an information device into sub-screens each having a predetermined size; a numerical key mapping unit for mapping the sub-screens obtained by the screen division unit to respective numerical keys provided on the information device; and a cursor movement unit for determining whether the numerical keys mapped by the numerical key mapping unit have been pressed, and moving the cursor to a sub-screen mapped to a corresponding numerical key and displaying the cursor if it is determined that a numerical key has been pressed. Preferably, the screen division unit secondarily may divide each sub-screen into secondary sub-screens each having a predetermined size a predetermined number of times, and the numerical key mapping unit may map the secondary sub-screens to respective numerical keys.

According to an embodiment of the present invention, the cursor movement unit may be constructed to move the cursor to a designated area of final sub-screens and display the cursor thereon so that the cursor is displayed together with first and second guidelines for identifying each area of the sub-screens or secondary sub-screens and first and second screen borders for indicating a size of the entire screen or each sub-screen.

According to another embodiment of the present invention, the cursor movement unit may be constructed so that the current location of the cursor is displayed together with the second guidelines and the second screen border. According to a further embodiment of the present invention, the cursor movement unit may be constructed so that the current location of the cursor is displayed together with the first guidelines and the first screen border on the final sub-screen.

In addition, the present invention provides a computer-readable recording medium on which a program for executing the method on a computer (including an information communication device having a computer function, such as a mobile phone) is recorded.

### BRIEF DESCRIPTION OF THE DRAWINGS

FIG. 1 is a block diagram showing the construction of an apparatus for moving a cursor using numerical keys according to an embodiment of the present invention;

FIG. 2 is a flowchart of a method of moving a cursor using numerical keys according to an embodiment of the present invention;

FIGS. 3a and 3b are views showing a cursor and an initial screen in an initialized state according to embodiments of the present invention;

FIG. 4 is a view showing 9 sub-screens M₁ to M₉ and the coordinates thereof when the size of a screen is 90×90 and the initial screen is divided into 9 small sub-screens; and

FIGS. 5a to 5c are views showing examples of screen division when a variable N indicating the number of times the screen is divided is 2.

### BEST MODE FOR CARRYING OUT THE INVENTION

Hereinafter, embodiments of the present invention will be described in detail with reference to the attached drawings.

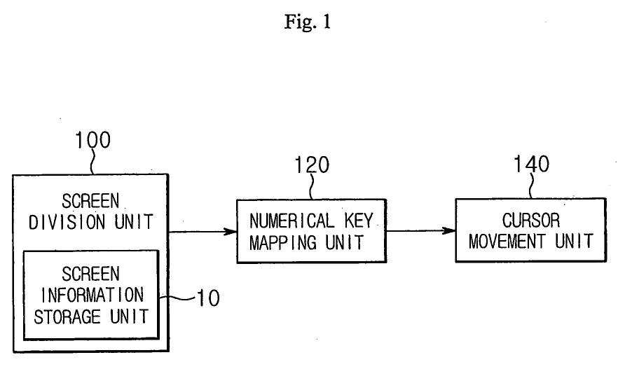

FIG. 1 is a block diagram showing the construction of an apparatus for moving a cursor using numerical keys according to an embodiment of the present invention. The cursor movement apparatus includes a screen division unit 100, a numerical key mapping unit 120 and a cursor movement unit 140.

The screen division unit 100 divides a screen of an information device into sub-screens each having a certain size. The screen division unit 100 secondarily divides each sub-screen into secondary sub-screens each having a certain size if predetermined secondary screen division conditions are satisfied. Preferably, each sub-screen is secondarily divided a predetermined number of times. The screen division unit 100 includes a screen information storage unit 10 for storing information about sub-screens or secondary sub-screens.

The numerical key mapping unit 120 maps the sub-screens obtained by the screen division unit 100 to respective numerical keys. Preferably, the numerical key mapping unit 120 maps the secondary sub-screens to respective numerical keys if each sub-screen is secondarily divided.

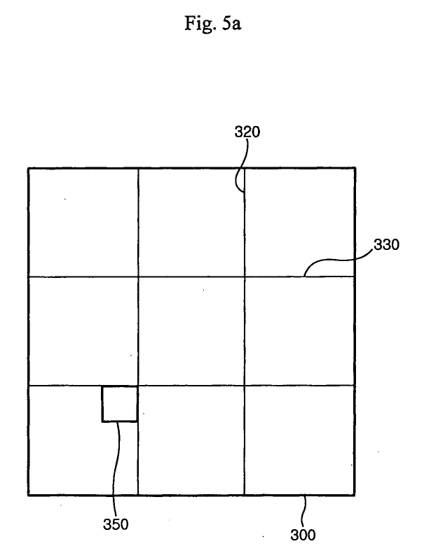

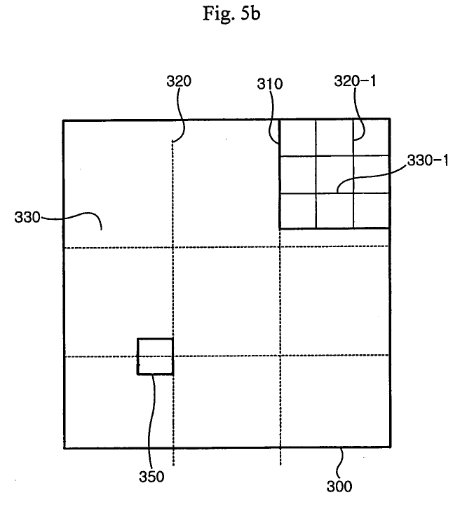

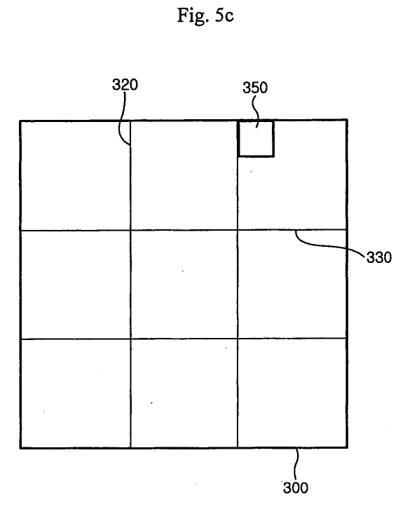

The cursor movement unit 140 locates the cursor on a corresponding sub-screen mapped by the numerical key mapping unit 120 using numerical keys, preferably, a center portion of the sub-screen, and displays the cursor in the center. The cursor movement unit 140 may display a screen border 310 (refer to FIG. 5b) on the location of the cursor moving using a corresponding numerical key mapped by the numerical key mapping unit 120 so that a sub-screen including the cursor can be distinguished from an entire screen area. Further, the cursor movement unit 140 may display guidelines 320, 320-1, 330 and 330-1 (refer to FIGS. 5a and 5b) for distinguishing the area of each sub-screen from the entire screen divided by the screen division unit, together with the screen border 310. The display of the screen border and the guidelines performed by the cursor movement unit can be selectively controlled using separate functional keys provided on the information device. Therefore, the display operation can be selectively controlled depending on the intention of the information device's user. In this case, a guideline denotes a virtual line for indicating a division location when a desired screen is divided once. In particular, guidelines described in the present invention show the case in which an entire screen is divided into 9 sub-screens. In this case, it is preferable that both lines for vertically dividing the screen and lines for horizontally dividing the screen be set to 2.

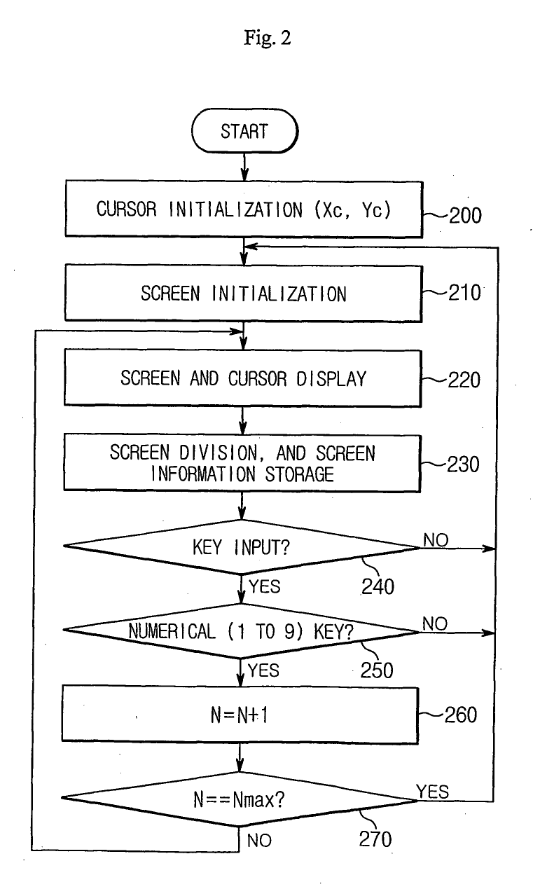

In the meantime, FIG. 2 is a flowchart of a method of moving a cursor using numerical keys according to the present invention. With reference to FIGS. 1 and 2, the operation of the present invention is described.

First, a cursor is initialized at step 200. At the cursor initialization step, the coordinates (Xc, Yc) of a cursor are obtained. Xc and Yc can be obtained if it is assumed that the cursor and the screen are a rectangle and the maximum values W, H or X, Y and the size of the rectangle Wc×Hc are used. In this case, Wc and Hc are obtained using a variable N indicating the number of times the screen is divided, or implemented using certain sizes. That is, Xc and Yc are obtained using Xc=(X−Wc)/2 and Yc=(Y−Hc)/2, where Wc=W/(number of horizontal keys)^{N} and Hc=H/(number of vertical keys)^{N}.

For example, if it is assumed that the size of a screen X×Y is 90×90, the size of the cursor Wc×Hc is 4×4, and the screen is divided into 9 sub-screens, the coordinates of the cursor can be the upper left corner point of a rectangle, having a certain size, formed on the basis of the coordinates (45, 45). That is, since Xc=(90−4)/2=43 and Yc=(90−4)/2=43 are obtained, the coordinates of the cursor (Xc, Yc) (43, 43) are obtained. Therefore, cursor information (Xc, Yc, Wc, Hc)=(43, 43, 4, 4) is obtained.

After the cursor is initialized, the screen is initialized at step 210. The screen initialization is performed through the initialization of variables x, y, w and h defining the screen. Variables x and y indicate coordinates at the upper left corner point on the screen, and variables w and h indicate the size of each sub-screen of the screen. The initialization values of the screen (x₀, y₀, w₀, h₀) are assigned to the screen variables (x, y, w, h). Further, if it is assumed that a variable, indicating the number of times the screen is divided, is N, N is set to 0.

For example, if the size of an initial screen is 90×90 and one initial screen exists, screen initialization is performed such that (x, y, w, h)=(0, 0, 90, 90) and N=0.

After the initialization of the cursor and the screen has been completed, the cursor and the screen are displayed at step 220. In this case, according to an embodiment of the present invention, the cursor and a screen border can be displayed. According to another embodiment of the present invention, guidelines for facilitating the selection of keys to move the cursor can be displayed together with the cursor and the screen border. The screen border is displayed at a location corresponding to x, y, w and h of the screen using screen information (x, y, w, h), and a cursor border is displayed on the screen using cursor information (Xc, Yc, Wc, Hc). Further, the guidelines on an X axis are indicated by (x, y+h/3, x+w, y+h/3) and (x, y+2h/3, x+w, y+2h/3), and the guidelines on a Y axis are indicated by (x+w/3, y, x+w/3, y+h), and (x+2w/3, y, x+2w/3, y+h).

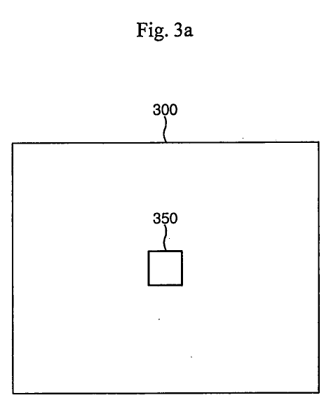

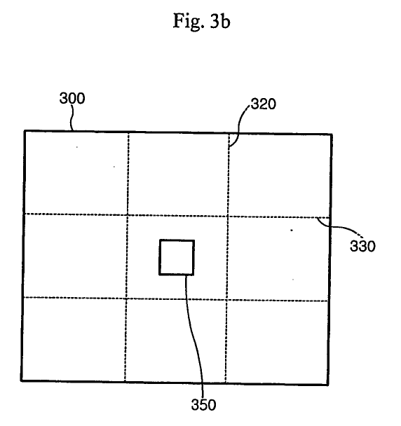

In this way, respective embodiments of the initialized screen are shown in FIGS. 3a and 3b. In FIGS. 3a and 3b, reference numeral 300 denotes a first screen border of the initial screen to be divided, reference numeral 350 denotes a cursor, the initial state of which is set to locate the cursor in the center of the initial screen, and reference numerals 320 and 330 denote first guidelines for vertically and horizontally dividing the initial screen, respectively. Preferably, the cursor is formed in a rectangular shape.

As shown in FIGS. 3a and 3b, after the screen and the cursor, or the screen, the cursor and the guidelines have been displayed, the screen is divided into certain sub-screens and the screen division information is stored at step 230.

Coordinate values are calculated as expressed by the following Equation [1], according to the form of numerical keys [123/456/789], on the basis of the input screen coordinate information (x, y, w, h),

w₁=w/3, h₁=h/3

x₁=x, x₂=x₁+w₁, x₃=x₂+w₁

y₁=y, y₂=y₁+h₁, y₃=y₂+h₁ [1]

where x, y, w and h correspond to variables when the process is implemented using software.

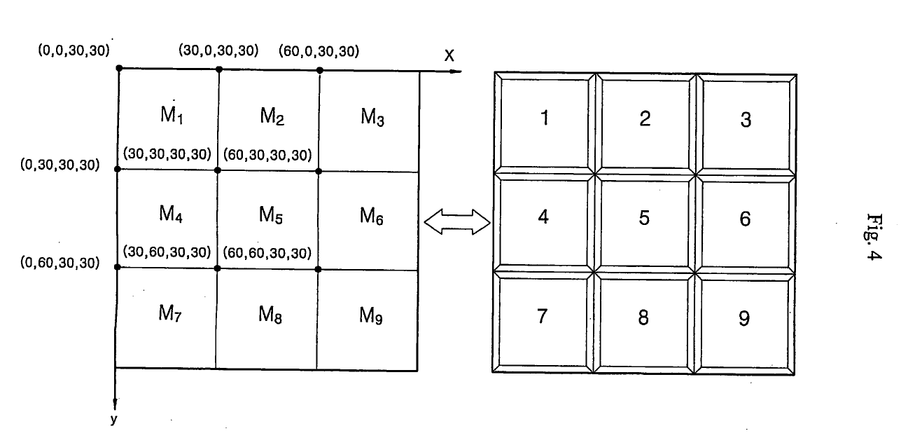

If dynamically or statically allocated memory is M, the calculated coordinate values are stored in the memory M. The memory M corresponds to the above-described screen information storage unit 10. For example, if the size of a screen is 90×90, and the initial screen is divided into 9 small sub-screens, the 9 sub-screens M₁ to Mg can be expressed as follows, as shown in FIG. 4.

M₁ (x₁, y₁, w₁, h₁)=M₁ (0, 0, 30, 30)

M₂ (x₂, Y₁, w₁, h₁)=M₂ (30, 0, 30, 30)

M₃ (x₃, y₁, w₁, h₁)=M₃ (60, 0, 30, 30)

M₄ (x₁, y₂, w₁, h₁)=M₄ (0, 30, 30, 30)

M₅ (x₂, y₂, w₁, h₁)=M₅ (30, 30, 30, 30)

M₆ (x₃, Y₂, w₁, h₁)=M₆ (60, 30, 30, 30)

M₇ (x₁, y₃, w₁, h₁)=M₇ (0, 60, 30, 30)

M₈ (x₂, y₃, w₁, h₁)=M₈ (30, 60, 30, 30)

M₉ (x₃, y₃, w₁, h₁)=M₉ (60, 60, 30, 30)

After the screen is divided and division information is stored, keys are pressed at step 240. Numerical keys are used as the keys. If the numerical keys numbered from 1 to 9 are pressed at step 250, screen information corresponding to the numerals is read from the screen information storage unit 10 by the numerical key mapping unit 120. If numerical keys numbered from 1 to 9 are pressed at step 250 in the case in which the process is implemented using software, screen information corresponding to numerals is read from memory M₁ to M₉, in which the screen information was stored at step 230, by the numerical key mapping unit 120, and the read values are assigned to the variables x, y, w and h, respectively.

Then, a variable N indicating the number of times the screen is divided is increased by 1 at step 260.

Further, the cursor (or the cursor and screen border, or the cursor, screen border and guidelines) is displayed on a sub-screen corresponding to the read screen information at step 220. The cursor may be located in a predetermined area of the sub-screen (the center or another preset area).

At this time, comparison is performed to determine whether the value N is greater than a preset maximum value Nmax. If the value N is less than Nmax, the coordinate values Xc and Yc of the cursor to be located in the center area are calculated on the basis of the screen information (x, y, w, h), so screen display is performed again, thus screen division continues. If the value N becomes equal to the maximum value Nmax, the process proceeds to step 210, and screen initialization is performed.

FIGS. 5a to 5c are views showing screen division when the variable N is 2. As described above according to the embodiment of the present invention, examples in which the first guidelines 320 and 330 on a primarily divided screen and second guidelines 320-1 and 330-1 on a secondarily divided screen are displayed are shown. In this case, on the initial screen of FIG. 5a, an initially preset state is depicted in which the cursor 350 is located in a lower left portion (in detail, an area corresponding to a “3” key within the area of a “7” key). It is apparent that the initial location of the cursor can vary according to a value set by the user, or a value set in an application program.

As shown in FIG. 5a, if the number of sub-screens formed by dividing the initial screen using two horizontal guidelines 330 and two vertical guidelines 320 is 9, a second screen border 310 and second guidelines 320-1 and 330-1 are displayed in a division area mapped to the numerical key “3”, as shown in FIG. 5b, when the user presses the “3” key while the cursor is located in the area of the initial “7” key. In this state, if a “1” key is pressed within a predetermined period of time, the cursor 350 is moved to an area corresponding to the “1” key within the area of the “3” key, as shown in FIG. 5c. Simultaneously, the second screen border 310 and the second guidelines 320-1 and 330-1 that have been displayed in FIG. 5b are removed from the screen, and the first screen border 300 and the first guidelines 320 and 330 are displayed on the screen together with the cursor 350.

In the meantime, if no numerical key is pressed within a predetermined period of time at the time of determining key pressing at step 240, or if an arbitrary key other than a numerical key is pressed at step 250, the cursor movement and screen division are interrupted and terminated, and another function is then performed, or the process returns to the screen initialization step. For example, if a “0” key is pressed immediately after a first, second or third numerical key has been pressed, an action corresponding to shooting can be performed when a game is a missile game.

The present invention can be implemented in a computer-readable recording medium (including any information communication device having an information processing function, such as a mobile phone) in the form of computer-readable code. A computer-readable recording medium includes all types of recording devices in which data readable by a computer system are stored. For example, the computer-readable recording medium may be Read-Only-Memory (ROM), Random-Access-Memory (RAM), Compact Disc (CD)-ROM, magnetic tape, a floppy disc, an optical data storage device, etc.

### INDUSTRIAL APPLICABILITY

As described above, the present invention provides a method and apparatus for moving a cursor using numerical keys, which can easily move the cursor to a desired location in an information communication device lacking a mouse.

Therefore, the present invention can perform a function similar to a mouse when a user plays a game, etc. using an information communication device lacking a mouse, such as a mobile phone.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-12. (canceled)

13. A method of moving a cursor to a desired location by displaying the cursor on a display screen of a small-sized information device having numerical keys and the display screen for graphic or data display, or by controlling location movement of the displayed cursor, comprising the steps of:
a) recognizing the coordinates of the display screen and calculating the size of the display screen, and dividing the display screen into sub-screens each having a predetermined size;
b) mapping the sub-screens recognized and divided at step a) to the numerical keys provided on the small-sized information device, respectively, and displaying a first screen border for indicating an entire screen and first guidelines for identifying each of the sub-screens mapped to the numerical keys, together with the cursor; and
c) determining whether the numerical keys mapped to the sub-screens at step b) have been pressed, and moving the cursor to the location of a sub-screen mapped to a corresponding numerical key and display the cursor of it is determined that the corresponding numerical key has been pressed.

14. The cursor movement method according to claim 13, wherein step b) further comprises the step of b2) secondarily dividing each sub-screen, mapped to each numerical key, into secondary sub-screens each having a predetermined size, and mapping the secondary sub-screens to respective numerical keys.

15. The cursor movement method according to claim 14, wherein step b2) is repeatedly performed a certain number of times.

16. The cursor movement method according to claim 13, wherein the number of sub-screens formed by dividing the screen is nine, and the numerical keys correspond to numerical keys numbered from 1 to 9.

17. The cursor movement method according to claim 13, wherein step c) comprises the steps of:
c1) if an arbitrary numerical key among the mapped numerical keys is pressed, displaying second guidelines for identifying respective secondary sub-screens in a sub-screen mapped to the numerical key and a second screen border for distinguishing an area of the sub-screen from the entire screen; and
c2) if an arbitrary numerical key or another numerical key is pressed while a display state of step c1) is maintained, moving the cursor to an area of a secondary sub-screen corresponding to the numerical key and displaying the cursor together with the first guidelines and the first screen border.

18. The cursor movement method according to claim 17, wherein step c1) comprises the step of removing the first screen border and the first guidelines displayed at step b) as a preprocessing step.

19. The cursor movement method according to claim 17, wherein step c2) further comprises the step of removing the second screen border and the second guidelines displayed at step c1) as a preprocessing step.

20. An apparatus for moving a cursor by displaying the cursor on a display screen of a small-sized information device having numerical keys and the display screen for graphic or data display, or by controlling location movement of the displayed cursor, comprising:
a screen division unit for recognizing the coordinates of the display screen and calculating the size of the display screen, and dividing the recognized display screen into sub-screens each having a predetermined size;
a numerical key mapping unit for mapping the sub-screens obtained and divided by the screen division unit to the numerical keys provided on the information device, respectively; and
a cursor movement unit for determining whether the numerical keys mapped by the numerical key mapping unit have been pressed, and moving the cursor to the location of a sub-screen mapped to a corresponding numerical key and displaying the cursor of it is determined that the numerical key has been pressed.

21. The cursor movement apparatus according to claim 20, wherein the screen division unit secondarily divides each sub-screen into secondary sub-screens, each having a predetermined size, a predetermined number of times, and the numerical key mapping unit maps the secondary sub-screens to respective numerical keys.

22. The cursor movement apparatus according to claim 20, wherein the cursor movement unit is constructed to move the cursor to a designated area of final sub-screens and display the cursor thereon so that the cursor is displayed together with first guidelines for identifying each area of the sub-screens and a first screen border for indicating a size of the entire screen.

23. A computer-readable recording medium on which a program for executing the method according to claim 13 on a computer is recorded.

24. A computer-readable recording medium on which a program for executing the method according to claim 14 on a computer is recorded.

25. A computer-readable recording medium on which a program for executing the method according to claim 15 on a computer is recorded.

26. A computer-readable recording medium on which a program for executing the method according to claim 17 on a computer is recorded.

27. A computer-readable recording medium on which a program for executing the method according to claim 18 on a computer is recorded.

28. A computer-readable recording medium on which a program for executing the method according to claim 19 on a computer is recorded.
